(19) United States
(12) Patent Application Publication
(10) Pub. No.: US 2017/0289536 A1
(43) Pub. Date: Oct. 5, 2017

(54) METHOD OF AUDIO DEBUGGING FOR TELEVISION AND ELECTRONIC DEVICE

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventor: Haowei PANG, Tianjin (CN)

(21) Appl. No.: 15/242,429

(22) Filed: Aug. 19, 2016

Related U.S. Application Data
(63) Continuation of application No. PCT/CN2016/088928, filed on Jul. 6, 2016.

(30) Foreign Application Priority Data
Mar. 31, 2016 (CN) 201610201952.9

(51) Int. Cl. H04N 17/00; H04N 5/60

(52) U.S. Cl. CPC H04N 17/004; H04N 5/60; H04N 2017/006

(57) ABSTRACT

The present disclosure relates to a method of audio debugging for television and an electronic device. In the method, when it is required to receive the audio in an external media source, the audio is sampled in an audio sampling rate of the audio and a sampling result obtained is stored; when it is required to play the audio, the sampling result is obtained again from the storage area and played. By the solution provided the disclosure, the television receives and plays an audio in an audio sampling rate of the audio itself, thereby avoiding the appearance of noise in the audio and improving the audio quality.

### CROSS REFERENCE TO RELATED APPLICATIONS

The present application is a continuation of International Application No. PCT/CN2016/088928, filed Jul. 6, 2016, which in turn claims priority to Chinese Application No. 201610201952.9, filed Mar. 31, 2016, the entire contents of which are incorporated herein by reference.

### TECHNICAL FIELD

The present disclosure relates to the technical field of terminal devices, and in particular, to a method of audio debugging for television and an electronic device.

### BACKGROUND

With the development of technology, the function of television is diversified increasingly. For example, now some televisions can be connected to external media sources such as DVD recorders and mobile storage devices to obtain audio-video information in the media source and play it, thereby satisfying diversified viewing requirements of users.

During the research and development of present invention, the inventor discovers that, when obtaining audio information provided by an external media source, the television may sample the audio information according to self audio sampling rate, and store the sampled audio information. When the audio is required to be played, the audio information is obtained from a storage area and played.

However, during the research and development of present invention, the inventor finds that, the audio sampling rates of some external media sources are different from the television. In this case, when the television obtains and plays an audio of the media source via its own audio sampling rate, noise may be occurred in the audio, which decreases the audio quality. For example, now the audio sampling rate of a television is generally set as 48 KHz while the audio sampling rates of some external media sources are lower than 48 KHz. When the television obtains and plays an audio of the media source by the audio sampling rate at 48 KHz, noise may be occurred in the audio.

### SUMMARY

To overcome the problem existing in the related technology, the present disclosure provides a method and device of audio debugging for television.

To solve the above technical problem, the present disclosure discloses the following technical solution.

According to a first aspect, the present disclosure provides a method of audio debugging for television, including:

obtaining an audio sampling rate of an audio when the audio in an external media source is required to be received;

sampling the audio according to the audio sampling rate of the audio and storing a sampling result into a storage area; and

obtaining the sampling result from the storage area and playing it when the audio is required to be played.

In a second aspect, the present disclosure further provides a nonvolatile computer storage media, which stores computer-executable instructions for executing any one of the method of audio debugging for television aforementioned.

In a third aspect, the present disclosure further provides an electronic device, which includes: one or more processors; and a memory; wherein the memory stores instructions that are executable by the one or more processors, and the instructions are configured to execute any one of the method of audio debugging for television aforementioned.

The technical solution of embodiments of the present disclosure may include the following advantageous effects.

The present disclosure discloses a method of audio debugging for television and an electronic device. In the present disclosure, when it is required to receive the audio in an external media source, the audio is sampled by an audio sampling rate of the audio and a sampling result obtained is stored; when it is required to play the audio, the sampling result is obtained again from the storage area and played. According to the present disclosure, the television receives and plays the audio in the audio sampling rate of the audio itself, thereby avoiding the appearance of noise in the audio and improving the audio quality.

It should be understood that, the above general description and the detailed description hereinafter are merely exemplary and explanatory, which are not used to limit the scope of the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a work flow chart of a method of audio debugging for television in accordance with some embodiments.

FIG. 2 is a structure diagram of a device of audio debugging for television in accordance with some embodiments.

FIG. 3 is a hardware structure diagram of a device of audio debugging for television in accordance with some embodiments.

### DETAILED DESCRIPTION

Here, exemplary embodiments are illustrated in details by way of example, wherein the examples are shown in the accompanying drawings. Where the description below relates to figures, unless otherwise indicates, the same reference numeral in different figures represents same or like elements. The examples described in exemplary embodiments below do not represent all embodiments in conformity with the present disclosure. On the contrary, they are merely examples of the device and method in conformity with some aspects of the present disclosure as defined in the accompanying claims.

The present disclosure discloses a method and device of audio debugging for television, in order to solve the problem in the prior art that an audio sometimes has noise when the television obtains and plays the audio of the media source in its own audio sampling rate of the audio.

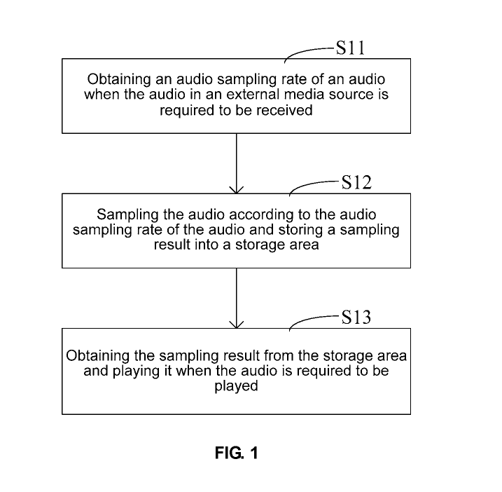

One embodiment of the present disclosure discloses a method of audio debugging for television. Referring to the work flow chart as shown in FIG. 1, the method of audio debugging for television includes the following steps.

Step S11: obtaining an audio sampling rate of an audio when the audio in an external media source is required to be received.

In the present disclosure, external media sources in multiple forms are supported. For example, the external media source may be a DVD recorder, a CD recorder, an USB flash disk or other mobile storage devices and STB (set-top box), etc. The present disclosure does not limit hereto.

Step S12: sampling the audio according to the audio sampling rate of the audio and storing a sampling result into a storage area.

The television has its own fixed audio sampling rate, but audios provided by external media sources may have various audio sampling rates. In this case, in the present disclosure, after obtaining an audio sampling rate of an audio itself, the television takes samples by the audio sampling rate of the audio.

Step S13: obtaining the sampling result from the storage area and playing it when the audio is required to be played.

The first embodiment of the present disclosure discloses a method of audio debugging for television. According to the method, when it is required to receive the audio in an external media source, the audio is sampled by an audio sampling rate of the audio and the sampling result obtained is stored; when it is required to play the audio, the sampling result is obtained again from the storage area and played. By the method, the television receives and plays an audio in an audio sampling rate of the audio itself, thereby avoiding the appearance of noise in the audio and improving the audio quality.

For example, if the audio sampling rate of the television is set as 48 KHz while the audio sampling rate of an audio in the external media source is 44.1 KHz, then the television receives and plays the audio by the audio sampling rate at 44.1 KHz, which avoids the occurrence of noise in the audio and ensures the audio quality.

Moreover, in the technical solution disclosed by the present disclosure, obtaining an audio sampling rate of the audio includes the following steps:

first of all, audio description information transmitted by the external media source is received;

then, an audio sampling rate of the audio contained in the audio description information is obtained by analyzing the audio description information.

The audio description information is generally packaged into a data package with audio. Besides, in the audio description information, an audio sampling rate of the audio is contained. Therefore, the audio sampling rate of the audio may be obtained by analyzing the audio description information.

Further, in the method of audio debugging for television as disclosed by the present disclosure, the operation of storing a sampling result into a storage area is disclosed. Wherein storing a sampling result into a storage area includes the following steps:

first of all, after obtaining an audio sampling rate of the audio by the audio description information, it is judged whether the audio sampling rates of the audio and the television are identical;

then, if the audio sampling rates of audio and the television are identical, the sampling result is stored into an original storage area of the television; if the audio sampling rates of audio and the television are different, a new storage area is created and the sampling result is stored into the new storage area.

In the prior art, the television receives audios provided by external media sources according to its own audio sampling rate, and stores the received audios into an original storage area of the television. In this case, in the present disclosure, if the audio sampling rates of the audio and the television are identical, the sampling result is stored into an original storage area of the television.

Moreover, if the audio sampling rates of the audio and the television are different, the television generally creates a new storage area and stores the sampling result into the new storage area, which makes it easy to search the audio when the audio is played.

Further, the method of audio debugging for television disclosed by the present disclosure further includes: building a corresponding relationship between the storage area for storing the sampling result and the sampling result when storing the sampling result.

If the sampling result is stored into an original storage area of the television, a corresponding relationship between the sampling result and the original storage area of the television is built; if the sampling result is stored into a new storage area, a corresponding relationship between the sampling result and the new storage area is built.

After building a corresponding relationship between the storage area of the sampling result and the sampling result, when it is required to play the audio, the corresponding storage area may be found according to the corresponding relationship; meanwhile, the sampling result stored in the storage area may be obtained and played.

Further, the method of audio debugging for television disclosed by the present disclosure further includes:

obtaining attribute information of the audio and storing a corresponding relationship between the attribute information of the audio and the audio sampling rate of the audio; obtaining the audio sampling rate of the audio according to the attribute information of the audio and the corresponding relationship, when the audio is required to be received again.

In above steps, after the audio sampling rate of an audio is obtained, a corresponding relationship between the attribute information of the audio and the audio sampling rate of the audio may be stored. In this case, when the audio is required to be received again, attribute information of the audio is obtained; then, the audio sampling rate of the audio is obtained according to the attribute information of the audio and the corresponding relationship, thus analyzing the audio description information is no longer needed.

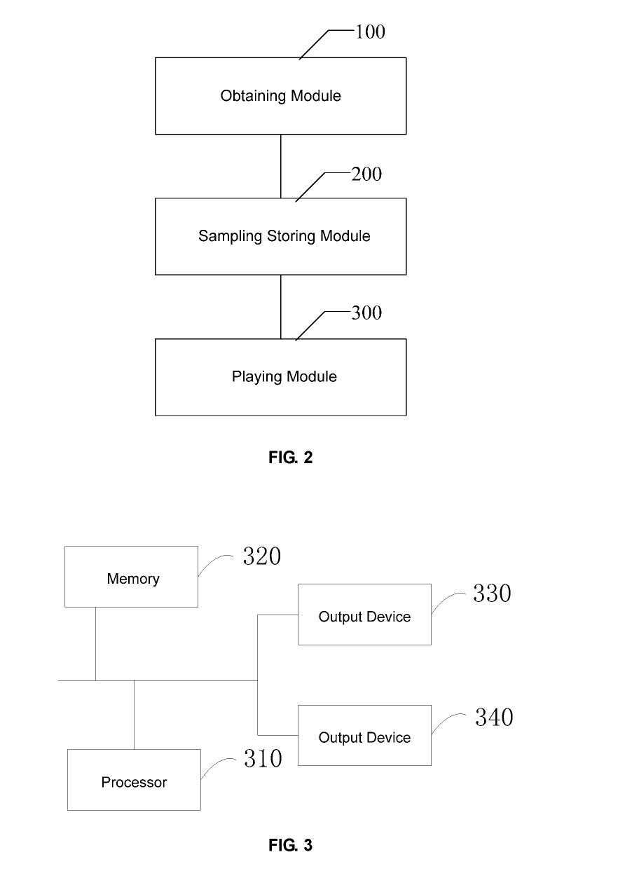

Correspondingly, the second embodiment of the present disclosure discloses a device of audio debugging for television. Referring to a structure diagram as shown in FIG. 2, the device of audio debugging for television includes: an obtaining module 100, a sampling storing module 200 and a playing module 300.

The obtaining module 100 is configured to obtain an audio sampling rate of an audio when the audio in an external media source is required to be received.

The sampling storing module 200 is configured to sample the audio according to the audio sampling rate of the audio and store a sampling result into a storage area.

The playing module 300 is configured to obtain the sampling result from the storage area and play it when the audio is required to be played.

The television has its own fixed audio sampling rate, but audios provided by external media sources may have various audio sampling rates. In this case, in the present disclosure, after obtaining an audio sampling rate of an audio itself, the television takes samples by the audio sampling rate of the audio.

The second embodiment of the present disclosure discloses a device of audio debugging for television. By the device, when it is required to receive the audio in an external media source, the audio is sampled by an audio sampling rate of the audio and a sampling result obtained is stored; when it is required to play the audio, the sampling result is obtained again from the storage area and played. By the method, the television receives and plays an audio in an audio sampling rate of the audio itself, thereby avoiding the appearance of noise in the audio and improving the audio quality.

For example, if the audio sampling rate of the television is set as 48 KHz while the audio sampling rate of an audio in external media sources is 44.1 KHz, then the television receives and plays the audio by the audio sampling rate at 44.1 KHz, which avoids the occurrence of noise in the audio and ensures the audio quality.

Further, the obtaining module 100 includes:

a description information receiving unit configured to receive audio description information transmitted by the external media source; and

a sampling rate obtaining unit configured to obtain an audio sampling rate of the audio contained in the audio description information by analyzing the audio description information.

The audio description information is generally packaged into a data package with audio. Besides, in the audio description information, an audio sampling rate of the audio is contained. Therefore, the audio sampling rate of the audio may be obtained by analyzing the audio description information.

Further, the sampling storing module 200 includes:

a judging unit configured to judge whether audio sampling rates of the audio and the television are identical after an audio sampling rate of the audio is obtained by the audio description information;

a first storing unit configured to store the sampling result into an original storage area of the television if the audio sampling rates of the audio and the television are identical; and

a second storing unit configured to create a new storage area if the audio sampling rates of the audio and the television are different and store the sampling result into the new storage area.

In the prior art, the television receives audios provided by external media sources according to its own audio sampling rate, and stores the received audios into an original storage area of the television. In this case, in the present disclosure, if the audio sampling rates of audio and the television are identical, the sampling result is stored into the original storage area of the television.

Moreover, if the audio sampling rates of the audio and the television are different, the television generally creates a new storage area and stores the sampling result into the new storage area, which makes it easy to search the audio when the audio is played.

Further, the device of audio debugging for television disclosed by the present disclosure further includes:

a first corresponding relationship building module configured to build a corresponding relationship between the storage area for storing the sampling result and the sampling result when storing the sampling result.

After building a corresponding relationship between the storage area of the sampling result and the sampling result, when it is required to play the audio, the corresponding storage area may be found according to the corresponding relationship; meanwhile, the sampling result stored in the storage area may be obtained and played.

Further, the device of audio debugging for television disclosed by the present disclosure further includes:

an attribute information building module configured to obtain attribute information of the audio;

a second corresponding relationship building module configured to store a corresponding relationship between the attribute information of the audio and the audio sampling rate of the audio; and

an audio sampling rate obtaining module configured to obtain the audio sampling rate of the audio according to the attribute information of the audio and the corresponding relationship, when the audio is required to be received again.

By the attribute information building module, the second corresponding relationship building module and the audio sampling rate obtaining module disclosed by the present disclosure, after the audio sampling rate of an audio is obtained, a corresponding relationship between the attribute information of the audio and the audio sampling rate of the audio may be stored. In this case, when the audio is required to be received again, the attribute information of the audio is obtained; then, the audio sampling rate of the audio is obtained according to the attribute information of the audio and the corresponding relationship, thus analyzing the audio description information is no longer needed.

With respect to the device in above embodiments, the specific modes for performing operation of each module have been described in details in the embodiments relevant to the method, and will not be illustrated here again in detail.

The embodiments of the present disclosure further provide a nonvolatile computer storage media, which stores computer-executable instructions for executing any one of the method of audio debugging for television aforementioned.

FIG. 3 is a hardware structure diagram of the electronic device for executing the method of audio debugging for television provided by embodiments of the present disclosure. Referring to FIG. 3, the device includes: one or more processors 310 and a memory 320. In FIG. 3, only one processor 310 is shown as an example.

The device for executing the method of audio debugging for television may further include: an input device 330 and an output device 340.

The processor 310, the memory 320, the input device 330 and the output device 340 may be connected by bus or other means. FIG. 3 shows the devices are connected by bus as an example.

The memory 320 is a nonvolatile computer-readable storage media, which may be used to store non-volatile software program, nonvolatile computer-executable program and module, such as the program instruction/module (e.g. the obtaining module 100, the sampling storing module 200 and the playing module 300 as shown in FIG. 2) corresponding to the method of audio debugging for television of the embodiments of the present disclosure. The processor 310 may perform various functions and applications of the server and process data by running the nonvolatile software program, instruction and module stored in the memory 320, so as to realize the method of audio debugging for television of the embodiments aforementioned.

The memory 320 may include a program storage area and a data storage area, wherein the program storage area may store an operation system and an application program for achieving at least one function; the data storage area may store data established according to the use of the device for playing video. In addition, the memory 320 may include a high-speed random access memory, and may further include a non-volatile memory, such as at least one magnetic disk memory, flash memory or other non-volatile solid state memory. In some examples, the memory 320 may preferably include memories set remotely with respect to the processor 310, wherein these remote memories may be connected to the device of audio debugging for television via the network. The examples of the network include but are not limited to internet, intranet, local area network (LAN), mobile communication network and their combinations.

The input device 330 may receive the information of a number or a character as inputted, and generate key input signals relating to the user setting and function control of the device of audio debugging for television. The output device 340 may include a display device such as a display screen.

The one or more modules are stored in the memory 320. When the one or more modules are executed by one or more processors 310, the method of audio debugging for television according to any of the above embodiments are executed.

The above product may execute the method provided by the embodiments of the present disclosure, and has the corresponding functional module for executing the method, and therefore has beneficial effect. For the details that are not fully described in this embodiment, please refer to the methods provided by the embodiments of the present disclosure.

The electronic device of the embodiments of the present disclosure may be embodied in various forms, which include but are not limited to the following device.

(1) Mobile communication device, which is characterized by the mobile communication function, and the main objective of which is to provide voice communication and data communication. This kind of terminal includes: smart phone (e.g. iPhone), multimedia phone, feature phone and low-level phone etc.

(2) Ultra mobile personal computer device, which belongs to the range of personal computer, has the function of computing and processing and generally can also be used in mobile internet. This kind of terminal includes: PDA, MID and UMPC device etc., such as iPad.

(3) Portable entertainment device, which may display and play multimedia contents. This kind of device includes: audio and/or video player (e.g. iPod), hand-held game machine, electronic book device, smart toy and portable vehicle navigation device.

(4) Server, which is a device that provides computing service. The configuration of the server includes processor, hard disk, memory and system bus etc. The architecture of a server is similar to that of a general computer. However, the sever has a higher demanding with respect to the processing ability, stability, reliability, safety, expansibility and manageability etc, because the server is required to provide more reliable service.

(5) Other electronic device having function of data interaction.

The embodiments of the device have been described above for illustrative purposes only, wherein the units described as separated members may or may not be separated physically. The members shown as units may or may not be physical unit, that is, they may be located at one place, or may be distributed to a number of units in a network. The objective of the embodiments of the present disclosure may be achieved by selecting a part or all of the modules according to actual demand.

From the description of the above embodiments, the person skilled in the art may understand clearly that respective embodiments may be implemented by software in combination with a hardware platform, or by hardware only. Based on this understanding, the nature or the part contributory to the prior art of the technical solution as described above may be embodied in the form a computer software product, which may be stored in a computer-readable storage media, such as ROM/RAM, magnetic disk, optical disk etc., and may include a number of instructions for making a computer device (which may be a personal computer, a server or a network device etc.) execute the method according to the respective embodiments or a part of an embodiment.

It should be noted that the embodiments as described above are only for the purpose of illustrating the solution of the present disclosure, without limiting the scope thereof. Although the present disclosure have been described according to the previous examples, the person skilled in the art will appreciate that various modifications to the solution recorded in the respective examples and equivalent substitutions for part of the features are possible, without departing from the scope and spirit of the present application as defined in the accompanying claims.

What is claimed is:

1. A method of audio debugging for television, which is applied to an electronic device, wherein the method comprises:
obtaining an audio sampling rate of an audio when the audio in an external media source is required to be received;
sampling the audio according to the audio sampling rate of the audio and storing a sampling result into a storage area; and
obtaining the sampling result from the storage area and playing it when the audio is required to be played.

2. The method of audio debugging for television according to claim 1, wherein the step of obtaining an audio sampling rate of the audio comprises:
receiving audio description information transmitted by the external media source; and
obtaining the audio sampling rate of the audio contained in the audio description information by analyzing the audio description information.

3. The method of audio debugging for television according to claim 2, wherein the step of storing a sampling result into a storage area comprises:
judging whether the audio sampling rates of the audio and the television are identical after obtaining the audio sampling rate of the audio by the audio description information;
storing the sampling result into an original storage area of the television if the audio sampling rates of the audio and the television are identical; and
creating a new storage area if the audio sampling rates of the audio and the television are different, and storing the sampling result into the new storage area.

4. The method of audio debugging for television according to claim 3, wherein the method further comprises:
building a corresponding relationship between the storage area for storing the sampling result and the sampling result when storing the sampling result.

5. The method of audio debugging for television according to claim 1, wherein the method further comprises:
obtaining attribute information of the audio and storing a corresponding relationship between the attribute information of the audio and the audio sampling rate of the audio; and
obtaining the audio sampling rate of the audio according to the attribute information of the audio and the corresponding relationship, when the audio is required to be received again.

6. A nonvolatile computer storage media, which stores computer-executable instructions, wherein the computer-executable instructions are configured to:
obtain an audio sampling rate of an audio when the audio in an external media source is required to be received;
sample the audio according to the audio sampling rate of the audio and store a sampling result into a storage area; and
obtain the sampling result from the storage area and play it when the audio is required to be played.

7. The nonvolatile computer storage media according to claim 6, wherein obtaining an audio sampling rate of the audio comprises:
receiving audio description information transmitted by the external media source; and
obtaining the audio sampling rate of the audio contained in the audio description information by analyzing the audio description information.

8. The nonvolatile computer storage media according to claim 7, wherein storing a sampling result into a storage area comprises:
judging whether the audio sampling rates of the audio and the television are identical after obtaining the audio sampling rate of the audio by the audio description information;
storing the sampling result into an original storage area of the television if the audio sampling rates of the audio and the television are identical; and
creating a new storage area if the audio sampling rates of the audio and the television are different, and storing the sampling result into the new storage area.

9. The nonvolatile computer storage media according to claim 8, wherein the computer-executable instructions are further configured to:
build a corresponding relationship between the storage area for storing the sampling result and the sampling result when storing the sampling result.

10. The nonvolatile computer storage media according to claim 6, wherein the computer-executable instructions are further configured to:
obtain attribute information of the audio and store a corresponding relationship between the attribute information of the audio and the audio sampling rate of the audio; and
obtain the audio sampling rate of the audio according to the attribute information of the audio and the corresponding relationship, when the audio is required to be received again.

11. An electronic device, comprising:
at least one processor; and
a memory communicating with the at least one processor;
wherein the memory stores instructions that are executable by the at least one processor, and the instructions are executed by the at least one processor so that the at least one processor is able to:
obtain an audio sampling rate of an audio when the audio in an external media source is required to be received;
sample the audio according to the audio sampling rate of the audio and store a sampling result into a storage area; and
obtain the sampling result from the storage area and play it when the audio is required to be played.

12. The electronic device according to claim 11, wherein obtaining an audio sampling rate of the audio comprises:
receiving audio description information transmitted by the external media source; and
obtaining the audio sampling rate of the audio contained in the audio description information by analyzing the audio description information.

13. The electronic device according to claim 12, wherein storing a sampling result into a storage area comprises:
judging whether the audio sampling rates of the audio and the television are identical after obtaining the audio sampling rate of the audio by the audio description information;
storing the sampling result into an original storage area of the television if the audio sampling rates of the audio and the television are identical; and
creating a new storage area if the audio sampling rates of the audio and the television are different, and storing the sampling result into the new storage area.

14. The electronic device according to claim 13, wherein the electronic device is further configured to:
build a corresponding relationship between the storage area for storing the sampling result and the sampling result when storing the sampling result.

15. The electronic device according to claim 11, wherein the electronic device is further configured to:
obtain attribute information of the audio and store a corresponding relationship between the attribute information of the audio and the audio sampling rate of the audio; and
obtain the audio sampling rate of the audio according to the attribute information of the audio and the corresponding relationship, when the audio is required to be received again.
